(19) United States
(12) Patent Application Publication
(10) Pub. No.: US 2025/0154678 A1
(43) Pub. Date: May 15, 2025

(54) JERK ELECTROLYTIC PROCESSING APPARATUS

(71) Applicant: NATIONAL TAIWAN NORMAL UNIVERSITY, Taipei (TW)

(72) Inventors: Shun-Tong Chen, Taipei (TW); Chi-Hsien CHIU, Taipei (TW)

(21) Appl. No.: 18/435,392

(22) Filed: Feb. 7, 2024

(30) Foreign Application Priority Data
Nov. 10, 2023 (TW) 112143445

(51) Int. Cl. C25D 5/18; C25D 5/04; C25D 17/12; C25D 21/12

(52) U.S. Cl. CPC C25D 5/18; C25D 5/04; C25D 17/12; C25D 21/12

(57) ABSTRACT

A jerk electrolytic processing apparatus is configured for processing a hole of a workpiece. The jerk electrolytic processing apparatus includes an electrolytic solution-providing device, a waveform generator, an electrode and a controller. The electrolytic solution-providing device is configured to provide an electrolytic solution to flow through the hole. The waveform generator is configured to generate a wave signal, and the wave signal is one of square wave, triangular wave and sine wave. The electrode is configured correspondingly to the hole of the workpiece. The electrode is configured to move in the hole along an axis of the hole. The controller is configured to generate a pulse current according to the wave signal. The controller applies the pulse current to the electrode and control the electrode to move in the hole with a jerk to process the inner wall surface of the hole for deforming the hole as a characteristic shape.

### BACKGROUND OF THE INVENTION

### 1. Field of the Invention

The present invention relates to the field of electrolytic machining, and more particularly, to a jerk electrolytic processing apparatus for processing holes of different shapes through electrolytic machining.

### 2. Description of the Prior Art

The nozzle is a commonly used mechanical part and is widely used in various fields. The nozzle usually has a tiny hole so that the liquid is sprayed in the form of mist from the tube through the nozzle by the pressure. With the trend of miniaturization and precision in the structure of mechanical parts, the nozzle can have a higher spray pressure and a better spray effect when the shape of nozzle holes is conical. For example, in the automotive industry, the conical micro-holes on the nozzles of a diesel engine can help to atomize fuel to improve fuel combustion efficiency and reduce emissions. In the biomedical industry, drugs can be sprayed on cardiac catheter stents through the conical micro-holes to prevent the occurrence of blood clots caused by the cardiac catheter stents in blood vessels. Furthermore, in the semiconductor industry, etching liquid can be sprayed on the materials that need to be removed through the nozzles with conical micro-holes to enhance machining accuracy.

Since the material of the nozzle is mostly alloy steel with high hardness and high strength that is resistant to corrosion and high temperatures, the conical micro-holes are difficult to form by traditional mechanical processing. The conical micro-holes of the current technology are usually formed by electrical discharge machining. However, due to the smaller taper rate (i.e., larger vacuum zone) of the conical micro-holes processed in the existing technology, the gas bubbles (e.g., hydrogen bubbles) are easily formed in the electrolytic solution of the workpiece during the electrolytic machining process. When the gas bubbles are formed between the electrode and the hole of the workpiece, the electrode is unable to process the workpiece through the electrolyte, so as to reduce the machining efficiency and the processing quality. In addition, most of the existing electrical discharge machining power supplies are direct current power supplies, and the electrode is continuously discharged during the machining process, increasing the gas bubbles generated by chemical reactions between the electrode and the workpieces, so as to decrease the processing quality.

Although the efficiency of the micro-holes formed by electrical discharge machining is high, the shape and accuracy of micro-holes are affected by the wear of the discharge electrode. Furthermore, although laser processing does not have the problem of electrode wear, the surface quality of the micro-holes is poor and prone to burrs. In addition, the existing technology can only process the ortho-conical micro-hole, so when the design or structural requirements require an inverted conical micro-hole, or even a micro-hole inner wall needs to be processed into a specific shape, the existing technology can not be achieved.

Therefore, it is necessary to develop a new type of electrolytic processing apparatus to solve the problems of the prior art.

### SUMMARY OF THE INVENTION

In view of this, the present invention is to provide a jerk electrolytic processing apparatus. According to an embodiment of the present invention, a jerk electrolytic processing apparatus is configured to process a hole of a workpiece. The jerk electrolytic processing apparatus comprises an electrolytic solution-providing device, a waveform generator, an electrode and a controller. The electrolytic solution-providing device is configured to provide an electrolytic solution to flow through the hole. The waveform generator is configured to generate a wave signal. The wave signal is one of square wave, triangular wave and sine wave. The electrode is configured correspondingly to the hole of the workpiece. The electrode is configured to move in the hole along an axis of the hole. The controller is connected to the waveform generator and the electrode. The controller is configured to generate a pulse current according to the wave signal. The controller applies the pulse current to the electrode and controls the electrode to move in the hole with a jerk to process the inner wall surface of the hole for deforming the hole as a characteristic shape.

Wherein, the electrode comprises a main body and a groove structure, the main body has a side surface, and the groove structure is disposed on the side surface.

Wherein, the electrode comprises an insulating layer covering the side surface of the main body, causing an end portion of the main body to be exposed to form a processing portion.

Wherein, the material of the insulating layer is parylene.

Wherein, the jerk electrolytic processing apparatus further comprises a grinding device disposed correspondingly to the electrode for grinding the end portion of the electrode to form the processing portion.

Wherein, the jerk comprises a first jerk and a second jerk, the controller controls the electrode to firstly move in the hole with the first jerk and then move in the hole with the second jerk.

Wherein, the controller controls the electrode to rotate at a speed and move in the hole with the jerk.

Wherein, the controller controls the electrode to move in the hole in a bottom-up direction, and the electrolytic solution flows through the hole in the bottom-up direction.

Wherein, the jerk electrolytic processing apparatus further comprises a power supply unit electrically connected to the workpiece, the electrode and the controller, the power supply unit providing positive power to the workpiece and negative power to the electrode, and the controller generating the pulse current according to the power supply unit and the wave signal.

Wherein, the jerk electrolytic processing apparatus further comprises a working platform disposed correspondingly to the electrode, the working platform comprises a flow channel and is configured to carry the workpiece, the flow channel is corresponding to the hole and is connected to the electrolytic solution-providing device.

In summary, the jerk electrolytic processing apparatus of the present invention can produce holes with a larger taper rate through the jerk electrolytic processing method, so that the workpiece is less likely to form gas bubbles in the electrolytic solution. In addition, the electrolytic solution can carry away the gas bubbles generated during the machining process more quickly, so as to enhance the machining efficiency and processing quality. Moreover, the jerk electrolytic processing apparatus of the present invention carries out the electrolytic processing with a pulse current, so that the electrode has a discharge rest time in the electrolytic processing process. At the same time, the generation of gas bubbles is further minimized and there is enough time for the electrolytic solution to take away the gas bubbles, so as to enhance the processing quality. Furthermore, the jerk electrolytic processing apparatus of the present invention can quickly output the gas bubbles generated during the processing through the groove structure of the electrode, so as to increase the stability of the electrolytic processing. In addition, the jerk electrolytic processing apparatus of the present invention can process the holes through the electrode in a variety of jerk-moving methods to produce micro-structures with various characteristics and shapes, so as to enhance the practicability and applicability of the products.

### BRIEF DESCRIPTION OF THE APPENDED DRAWINGS

FIG. 1 is a schematic diagram illustrating a jerk electrolytic processing apparatus according to an embodiment of the present invention.

FIG. 2 is a function block diagram illustrating the jerk electrolytic processing apparatus according to an embodiment of the present invention.

FIG. 3 is a cross-sectional diagram illustrating a working platform and a workpiece of FIG. 1.

FIG. 4A is a schematic diagram illustrating an electrode of FIG. 1.

FIG. 4B is a cross-sectional diagram illustrating the electrode and the workpiece of FIG. 1 during electrolytic processing.

FIG. 5A is a curve chart illustrating a jerk according to an embodiment of the present invention.

FIG. 5B is a cross-sectional diagram illustrating a workpiece after the electrode machining with the jerk of FIG. 5A.

FIG. 6A is a curve chart illustrating a jerk according to an embodiment of the present invention.

FIG. 6B is a cross-sectional diagram illustrating a workpiece after an electrode machining with the jerk of FIG. 6A.

FIG. 7A is a curve chart illustrating a jerk according to an embodiment of the present invention.

FIG. 7B is a cross-sectional diagram illustrating a workpiece after the electrode machining with the jerk of FIG. 7A.

FIG. 8A is a curve chart illustrating a jerk according to an embodiment of the present invention.

FIG. 8B is a cross-sectional diagram illustrating a workpiece after the electrode machining with the jerk of FIG. 8A.

### DETAILED DESCRIPTION OF THE INVENTION

For the sake of the advantages, spirits and features of the present invention can be understood more easily and clearly, the detailed descriptions and discussions will be made later by way of the embodiments and with reference of the diagrams. It is worth noting that these embodiments are merely representative embodiments of the present invention, wherein the specific methods, devices, conditions, materials and the like are not limited to the embodiments of the present invention or corresponding embodiments. Moreover, the devices in the figures are only used to express their corresponding positions and are not drawing according to their actual proportion.

In the description of this specification, the description with reference to the terms “an embodiment”, “another embodiment” or “part of an embodiment” means that a particular feature, structure, material or characteristic described in connection with the embodiment including in at least one embodiment of the present invention. In this specification, the schematic representations of the above terms do not necessarily refer to the same embodiment. Furthermore, the particular features, structures, materials or characteristics described may be combined in any suitable manner in one or more embodiments. Furthermore, the indefinite articles “a” and “an” preceding a device or element of the present invention are not limiting on the quantitative requirement (the number of occurrences) of the device or element. Thus, “a” should be read to include one or at least one, and a device or element in the singular also includes the plural unless the number clearly refers to the singular.

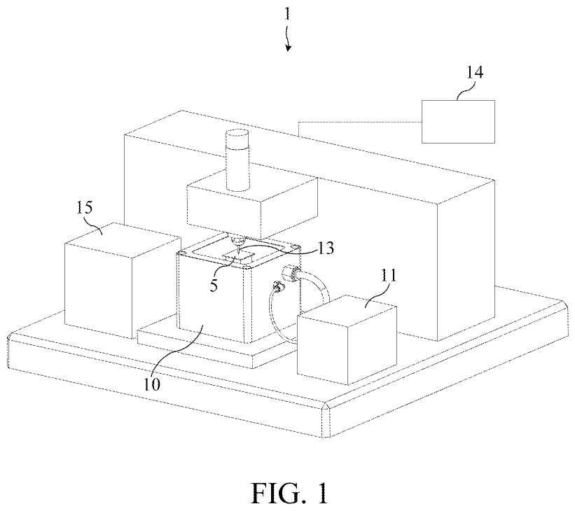

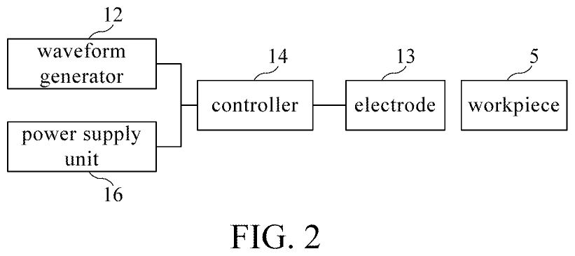

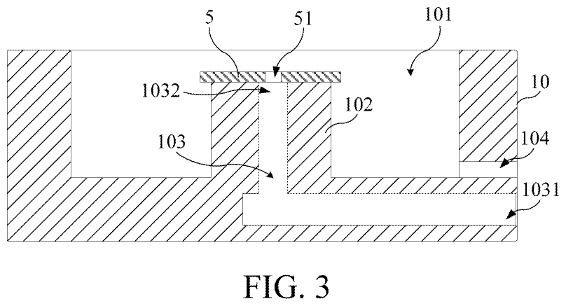

Please refer to FIG. 1, FIG. 2 and FIG. 3. FIG. 1 is a schematic diagram illustrating a jerk electrolytic processing apparatus 1 according to an embodiment of the present invention. FIG. 2 is a function block diagram illustrating the jerk electrolytic processing apparatus 1 according to an embodiment of the present invention. FIG. 3 is a cross-sectional diagram illustrating a working platform 10 and a workpiece 5 of FIG. 1. As shown in FIG. 1 and FIG. 2, the jerk electrolytic processing apparatus 1 of the present embodiment is configured to process a hole 51 of a workpiece 5 and contains a working platform 10, an electrolytic solution-providing device 11, a waveform generator 12, an electrode 13 and a controller 14. The working platform 10 is disposed correspondingly to the electrode 13, and the electrode 13 is disposed on the working platform 10. The electrolytic solution-providing device 11 is connected to the working platform 10. The controller 14 is connected to the waveform generator 12 and an electrode 13.

As shown in FIG. 1 and FIG. 3, in the present embodiment, the working platform 10 is configured to carry the workpiece 5. In practice, the working platform 10 can comprise a recess 101 and a carrier platform 102. The carrier platform 102 can protrude upward from the bottom of the recess 101 and be configured to carry the workpiece 5. The workpiece 5 can be fixed to the carrier platform 102 by locking, clamping, etc. Furthermore, in the present embodiment, the work platform 10 comprises a flow channel 103. The flow channel 103 is corresponding to the hole 51 of the workpiece 5 and is connected to the electrolytic solution-providing device 11. As shown in FIG. 3, the flow channel 103 can comprise an inlet 1031 and an outlet 1032. The inlet 1031 is located on the side wall of the work platform 10 and is connected to the electrolytic solution-providing device. The outlet 1032 is located on the carrier platform 102 and is connected to the hole 51 of the workpiece 5 and the recess 101.

In the present embodiment, the electrolytic solution-providing device 11 is configured to provide an electrolytic solution to flow to the inlet 1031. When the electrolytic solution-providing device 11 provides the electrolytic solution to the working platform 10, the electrolytic solution can through the hole 51 of the workpiece 5 through the flow channel 103 and flow to the recesses 101 through the hole 51. In practice, as shown in FIG. 3, the working platform 10 can further comprise an output channel 104 connected to the recess 101 and to the electrolytic solution-providing device 11. After the electrolytic solution supplied by the electrolytic solution-providing device 11 flows from the flow channel 103 through the hole 51 of the workpiece 5, the electrolytic solution can further flow to the recess 101 and through the output channel 104 flow back to the electrolytic solution-providing device 11. Therefore, the electrolytic solution can sequentially flow through the inlet 1031, the flow channel 103, the outlet 1032, the hole 51 of the workpiece 5, the recess 101, and the output channel 104 to form an electrolytic solution-providing circuit. It is worth noting that in practice, the output channel cannot be connected to the electrolytic solution-providing device, i.e., the electrolytic solution flowing from the recess cannot flow back to the electrolytic solution-providing device.

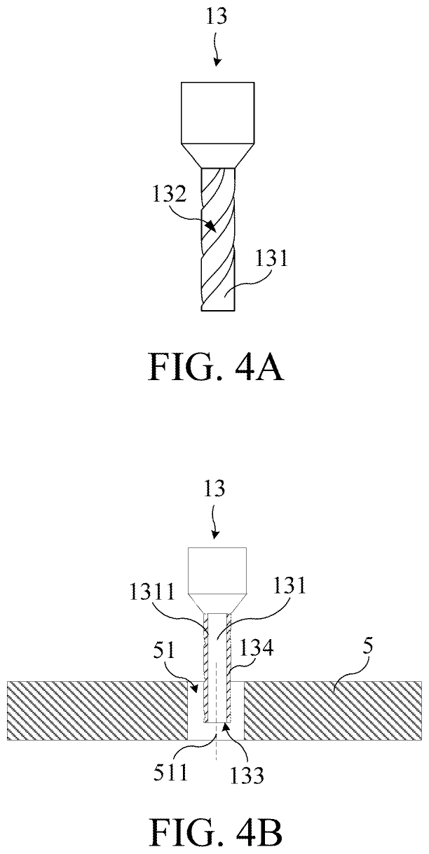

Please refer to FIG. 1, FIG. 2, FIG. 4A and FIG. 4B. FIG. 4A is a schematic diagram illustrating an electrode 13 of FIG. 1. FIG. 4B is a cross-sectional diagram illustrating the electrode 13 and the workpiece 5 of FIG. 1 during electrolytic processing. In practice, the electrode 13 comprises a main body 131, a groove structure 132 and a processing portion 133. The main body 131 has a side surface 1311, and the groove structure 132 is disposed on the side surface 1311. The processing portion 133 is located at an end portion of the main body 131 and faces the workpiece 5. As shown in FIG. 4A, the main body 131 of the electrode 13 is substantially in cylindrical shape and the groove structure 132 is a spiral groove. In practice, the material of the electrode 13 can be tungsten carbide but is not limited to the aforementioned. The groove structure 132 can be formed by machining, and the number and the shape of the groove structure 132 can be determined according to design or demand. In the present embodiment, the shape of the processing portion 133 of the electrode 13 is planar, but it is not limited to the aforementioned in practice, and the shape of the processing portion 133 can be a bump, a round arc, a cone shape, etc.

In the present embodiment, the electrode 13 comprises an insulating layer 134 covering the side surface 1311 of the main body 131. In practice, the insulating layer 134 can be coated on the main body 131 such as by chemical vapor deposition (CVD). Furthermore, the insulating layer 134 of the electrode 13 is not covered on the end surface of the main body 131, causing the end portion of the main body 131 to be exposed to form a processing portion 133. That is, the electrode 13 is electrolytically processed only with the processing portion 133 at the end portion of the main body 131. As shown in FIG. 4B, the hole 51 of the workpiece 5 has an axis 511, and the electrode 13 moves in the hole 51 along the axis 511 of the hole 51 for electrolytic processing. During the electrolytic processing, the processing portion 133 of the main body 131 of the electrode 13 generates an electric field and an electrochemical reaction with an inner wall of the hole 51 through the electrolytic solution, so as to cause the inner wall of the hole 51 to be concave due to electrolysis, and then to produce a characteristic shape. The side surface 1311 does not generate an electrochemical reaction with the inner wall of the hole 51. It should be noted that in practice, the electrode 13 can be machined with the groove structure 132 and then coated to form the insulating layer 134.

In practice, the material of the insulating layer 134 can be Poly-para-xylylene (also known as Parylene). The Parylene has good heat resistance, corrosion resistance, electrical insulation, and mechanical strength. Therefore, when the electrode 13 is in the electrolytic processing, the main body 131 of the electrode 13 will not be damaged by the electrolytic solution, and leakage and discharge can be effectively prevented, so that the electrode 13 will only be processed by the processing section 133, so as to improve the processing quality. In practice, the material of the insulating layer 134 is not limited to the above-mentioned materials, but can also be other insulating materials.

In the present embodiment, the controller 14 is configured to control the movement of the electrode 13 in the hole 51 of the workpiece 5. In practice, the controller 14 and the electrode 13 can be connected to a drive element (e.g., motor, cylinder, screw, etc.), and the controller 14 can control the drive element to drive the electrode 13 in a horizontal or vertical direction. Therefore, the controller 14 can control the electrode 13 to move in the hole 51 along an axis 511 of the hole 51.

Furthermore, in the present embodiment, the controller 14 controls the electrode 13 to rotate at a speed and simultaneously move in the hole 51 of the workpiece 5 for electrolytic machining. In practice, the controller 14 can control the electrode 13 to rotate at a rotational speed of 1000 rpm, 2000 rpm, 3000 rpm, 4000 rpm, or 5000 rpm or more. Since the electrode 13 rotate in the hole 51, the electrode 13 can drive the electrolytic solution between the electrode 13 and the hole 51 to flow uniformly, causing the electrolytic processing response to be more uniform, so as to minimize and remove burrs generated during the processing, and further improve the processing efficiency and the processing quality.

As shown in FIG. 2, in the present embodiment, the jerk electrolytic processing apparatus 1 further comprises a power supply unit 16 electrically connected to the workpiece 5, the electrode 13 and the controller 14. The power supply unit 16 can provide positive power to the workpiece 5 and negative power to the electrode 13. In practice, the power supply unit 16 can be a direct current power supply and be configured to provide electrical energy. The controller 14 controls and applies the electrical energy provided by the power supply unit 16 to the workpiece 5 and the electrode 13 for electrolytic processing.

In the present embodiment, the waveform generator 12 is configured to generate a wave signal. The controller 14 generates a machining current according to the electrical energy provided by the power supply unit 16 and the waveform signal, and the controller 14 applies the machining current to the workpiece 5 and the electrode 13 for processing. In the present embodiment, the waveform signal can be a square wave, a triangular wave or a sine wave. Therefore, the machining current generated by the controller 14 according to the electrical energy provided by the power supply unit 16 and the waveform signal is a pulse current.

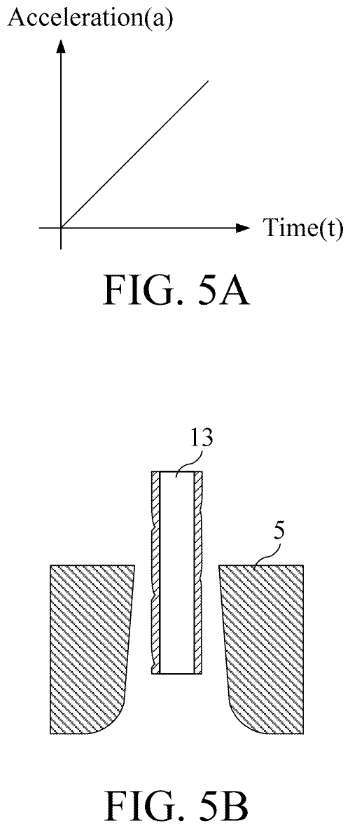

Please refer to FIG. 2, FIG. 4B, FIG. 5A, and FIG. 5B. FIG. 5A is a curve chart illustrating a jerk according to an embodiment of the present invention. FIG. 5B is a cross-sectional diagram illustrating a workpiece 5 after the electrode 13 machining with the jerk of FIG. 5A. In the present embodiment, the controller 14 applies a pulse current to the electrode 13 and controls the electrode 13 to move in the hole 51 of the workpiece 5 with the jerk of FIG. 5A for electrolytic machining. As shown in FIG. 4B and FIG. 5A, the controller 14 controls the electrode 13 to move in the hole 51 from the bottom of the hole 51 in a bottom-up direction and at a speed of positive jerk. That is, the electrode 13 moves vertically upward from the bottom of the hole 51 in a slow-to-fast manner. The electrolytic solution also flows through the hole 51 from the bottom of the hole 51 in the bottom-up direction, i.e., the electrode 13 and the electrolytic solution move in the same direction. Since the movement speed of the electrode 13 in the hole 51 is inversely proportional to the degree of the electrochemical reaction, the electrochemical reaction is greatest when the electrode 13 is at the bottom of the hole 51, and the degree of depression of the inner wall surface of the hole 51 is greatest. The movement of the electrode 13 in the hole 51 is gradually accelerated, and the degree of electrochemical reaction and the degree of depression of the inner wall surface of the hole 51 is gradually decreased. The electrochemical reaction is smallest when the electrode 13 is at the top of the hole 51, and the degree of depression of the inner wall surface of the hole 51 is smaller, so as to generate a hole 51 in an inverted conical shape (as shown in FIG. 5B).

Since the electrode 13 moves in the bottom of the hole 51 with the smallest speed, the bottom of the hole 51 has a larger taper rate (i.e., a smaller vacuum zone) after electrolytic processing. As a result, the workpiece 5 is less likely to form gas bubbles in the electrolytic solution during the electrolytic processing, so as to enhance the processing efficiency. Furthermore, since the electrochemical reaction of the electrode 13 is greatest at the bottom of the hole 51, i.e., the size of the hole 51 is larger at the bottom, the electrolytic solution can pass through the hole more quickly, so as to carry away the gas bubbles generated during the machining process faster, and further improve the machining efficiency and processing quality. Moreover, when the electrolytic solution flows through the holes 51, the electrolytic solution also passes through the groove structure of the electrode 13. Therefore, the gas bubbles generated during the processing can be quickly outputted through the groove structure, so as to increase the stability of electrolytic processing. In addition, the electrode 13 is processed with the pulse current, i.e., there is a discharge rest time in the electrolytic processing process to minimize the generation of gas bubbles and have enough time for the electrolytic solution to take away the gas bubbles, so as to enhance the processing quality.

Please refer again to FIG. 1. In the present embodiment, the jerk electrolytic processing apparatus 1 further comprises a grinding device 15 disposed correspondingly to the electrode 13 and adjacent to the working platform 10. In practice, the grinding device 15 can include sandpaper, abrasive pads, whetstones, etc. After the electrode 13 is coated with the insulating layer, the controller 14 can control the movement of the electrode 13 to the grinding device 15 through the drive element. The grinding device 15 can grind the end portion of the electrode 13 to remove the insulating layer of the end portion, so that the main body of the electrode 13 is exposed at the end portion to form the processing portion. In addition, when the processing portion of the electrode 13 is dirty, damaged or sticky with impurities due to multiple processing, the controller 14 can also control the electrode 13 to move to the grinding device 15 to grind the processing portion to ensure processing efficiency and stability.

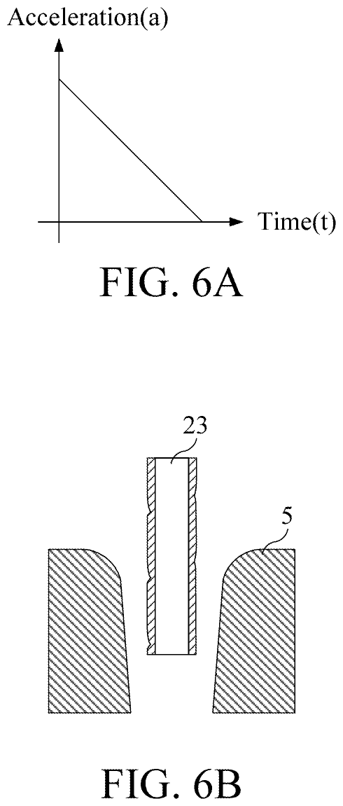

The processing method of the jerk electrolytic processing apparatus of the present invention can be other patterns besides the aforementioned pattern. Please refer to FIG. 6A and FIG. 6B. FIG. 6A is a curve chart illustrating a jerk according to an embodiment of the present invention. FIG. 6B is a cross-sectional diagram illustrating a workpiece 5 after an electrode 23 machining with the jerk of FIG. 6A. As shown in FIG. 6A and FIG. 6B, the difference between the present embodiment and the aforementioned embodiment is that the controller of the present embodiment controls the electrode 23 to move in the hole from the bottom of the hole in a bottom-up direction and at a speed of negative jerk. In other words, the electrode 23 moves vertically upward from the bottom of the hole in a fast-to-slow manner, so as to generate a hole in an ortho-conical shape (as shown in FIG. 6B).

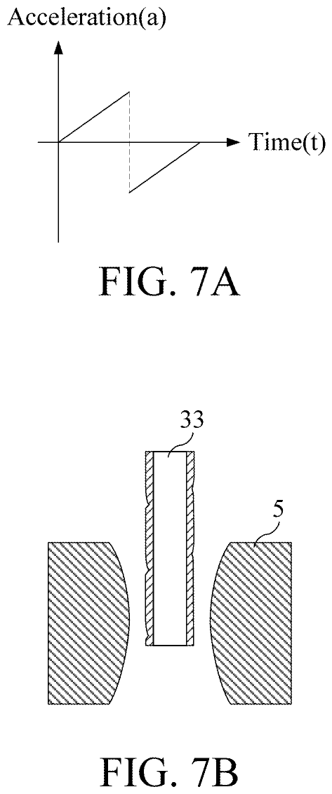

Please refer to FIG. 7A and FIG. 7B. FIG. 7A is a curve chart illustrating a jerk according to an embodiment of the present invention. FIG. 7B is a cross-sectional diagram illustrating a workpiece 5 after the electrode 33 machining with the jerk of FIG. 7A. In the present embodiment, the jerk comprises a first jerk and a second jerk, and the first jerk is different from the second jerk. As shown in FIG. 7A, the controller first controls the electrode 33 to move in the hole with the first jerk from an initial jerk of 0 and at a speed of positive jerk, and then controls the electrode 33 to instantaneously move in the hole with the second jerk from a negative initial jerk and at a speed of positive jerk. In other words, the electrode 33 moves vertically upward from the bottom of the hole in a slow-to-fast and fast-to-slow manner to produce a funnel-shaped (inwardly contracted) hole (as shown in FIG. 7B).

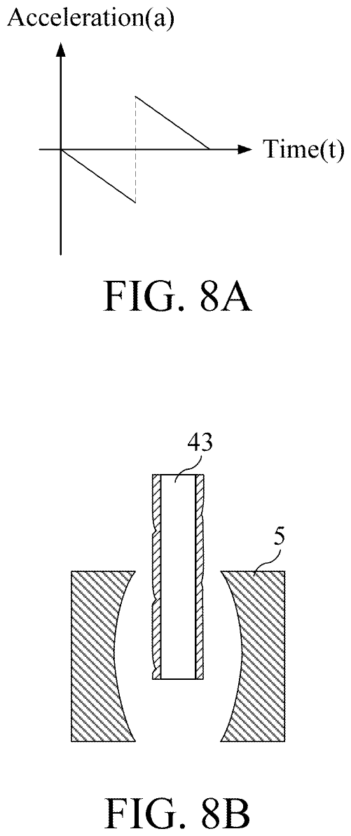

Please refer to FIG. 8A and FIG. 8B. FIG. 8A is a curve chart illustrating a jerk according to an embodiment of the present invention. FIG. 8B is a cross-sectional diagram illustrating a workpiece 5 after the electrode 43 machining with the jerk of FIG. 8A. As shown in FIG. 8A and FIG. 8B, the difference between the present embodiment and the aforementioned embodiment is that the controller first controls the electrode 43 to move in the hole with the first jerk from an initial jerk of 0 and at a speed of negative jerk, and then controls the electrode 43 to instantaneously move in the hole with the second jerk from a positive initial jerk and at a speed of negative jerk. In other words, the electrode 43 moves vertically upward from the bottom of the hole in a fast-to-slow and slow-to-fast manner to produce an inwardly expanding hole (as shown in FIG. 8B).

In summary, the jerk electrolytic processing apparatus of the present invention can produce holes with a larger taper rate through the jerk electrolytic processing method, so that the workpiece is less likely to form gas bubbles in the electrolytic solution, and the electrolytic solution can carry away the gas bubbles generated during the machining process more quickly, so as to enhance the machining efficiency and processing quality. Moreover, the jerk electrolytic processing apparatus of the present invention carries out the electrolytic processing with a pulse current, so that the electrode has a discharge rest time in the electrolytic processing process to minimize the generation of gas bubbles and have enough time for the electrolytic solution to take away the gas bubbles, so as to enhance the processing quality. Furthermore, the jerk electrolytic processing apparatus of the present invention can quickly output the gas bubbles generated during the processing through the groove structure of the electrode, so as to increase the stability of the electrolytic processing. In addition, the jerk electrolytic processing apparatus of the present invention can process the holes through the electrode in a variety of jerk-moving methods to produce micro-structures with various characteristics and shapes, so as to enhance the practicability and applicability of the products.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A jerk electrolytic processing apparatus for processing a hole of a workpiece, comprising:
an electrolytic solution-providing device, configured to provide an electrolytic solution to flow through the hole;
a waveform generator, configured to generate a wave signal, and the wave signal being one of square wave, triangular wave and sine wave;
an electrode, configured correspondingly to the hole of the workpiece, and configured to move in the hole along an axis of the hole; and
a controller, connected to the waveform generator and the electrode, the controller being configured to generate a pulse current according to the wave signal, apply the pulse current to the electrode and control the electrode to move in the hole with a jerk to process the inner wall surface of the hole for deforming the hole as a characteristic shape.

2. The jerk electrolytic processing apparatus of claim 1, wherein the electrode comprises a main body and a groove structure, the main body has a side surface, and the groove structure is disposed on the side surface.

3. The jerk electrolytic processing apparatus of claim 2, wherein the electrode comprises an insulating layer covering the side surface of the main body, causing an end portion of the main body to be exposed to form a processing portion.

4. The jerk electrolytic processing apparatus of claim 3, wherein the material of the insulating layer is parylene.

5. The jerk electrolytic processing apparatus of claim 3, further comprising a grinding device disposed correspondingly to the electrode for grinding the end portion of the electrode to form the processing portion.

6. The jerk electrolytic processing apparatus of claim 1, wherein the jerk comprises a first jerk and a second jerk, the controller controls the electrode to firstly move in the hole with the first jerk and then move in the hole with the second jerk.

7. The jerk electrolytic processing apparatus of claim 1, wherein the controller controls the electrode to rotate at a speed and move in the hole with the jerk.

8. The jerk electrolytic processing apparatus of claim 1, wherein the controller controls the electrode to move in the hole in a bottom-up direction, and the electrolytic solution flows through the hole in the bottom-up direction.

9. The jerk electrolytic processing apparatus of claim 1, further comprising a power supply unit electrically connected to the workpiece, the electrode and the controller, the power supply unit providing positive power to the workpiece and negative power to the electrode, and the controller generating the pulse current according to the power supply unit and the wave signal.

10. The jerk electrolytic processing apparatus of claim 1, further comprising a working platform disposed correspondingly to the electrode, the working platform comprising a flow channel and being configured to carry the workpiece, the flow channel being corresponding to the hole and connected to the electrolytic solution-providing device.
